(19) United States
(12) Patent Application Publication
(10) Pub. No.: US 2013/0304343 A1
(43) Pub. Date: Nov. 14, 2013

(54) Method and Device for Operating Compressed-Air Brakes

(71) Applicant: WABCO Gmbh, Hannover (DE)

(72) Inventors: Konrad Feyerabend, Hannover (DE); Otmar Struwe, Hannover (DE)

(21) Appl. No.: 13/787,957

(22) Filed: Mar. 7, 2013

(30) Foreign Application Priority Data
May 10, 2012 (DE) DE102012009185.0

(51) Int. Cl. B60T 17/22; B60T 13/66

(52) U.S. Cl. CPC B60T 17/221; B60T 13/66
USPC 701/70

(57) ABSTRACT

A method and brake control device, with closed-loop braking intervention control functionality, for operating a vehicle compressed-air brake system includes directly processing data representing at least one pressure measurement of the compressed air, such as the pressure in the brake circuit(s) and/or the system pressure. Brake system leaks can be detected even when the vehicle is operating.

### CROSS-REFERENCE TO RELATED APPLICATION

This application claims the benefit of DE 10 2012 009 185 filed on May 10, 2012, the disclosure of which is hereby incorporated herein by reference in its entirety.

### FIELD OF THE INVENTION

The present invention generally relates to methods and devices for controlling vehicle compressed-air brakes.

### BACKGROUND OF THE INVENTION

Heavy vehicles such as trucks, with or without trailers, as well as buses etc. are equipped with compressed-air brakes. For safety reasons, a heavy vehicle brake system can have brake circuits that are independent of one another. In many countries, an anti-lock brake system (ABS) is provided as a closed-loop braking intervention control for heavy vehicles. The ABS is controlled by a separate electronic brake control device. Such a control device can also be provided in vehicles for other purposes and is referred to as an ECU (electronic control unit). The ECU provided for the ABS typically evaluates only the data required for braking free of locking.

Modern vehicles are equipped with electronic brake systems (EBS). In an EBS, the position of the brake pedal is sensed electronically and converted into a signal for actuating the brakes. This involves an electronic-pneumatic system provided parallel to the mechanical-pneumatic system, which is present in any case, with the result that, in the event of failure of the electronics, the compressed-air brakes can still be activated. The function of the ABS, as well as further functions for influencing driving behavior, are also typically integrated into the EBS. These functions are, to a certain extent, given different designations by the various manufacturers, for example: ETCS (electronic traction control system) and ESP (electronic stability program).

Sensors and actuators are assigned to specific ECUs. The ECUs read out data from the sensors and actuators assigned to them. The ECUs exchange data with other ECUs via a databus. The ECUs also exchange data with the EBS. In vehicles, a CAN bus is typically provided as a databus. The resolution and speed of the CAN databus are relatively low but sufficient for the purposes of the EBS. The same applies when an ABS or some other closed-loop braking intervention control is provided instead of the EBS.

In addition to the ECU for an ABS or EBS, further ECUs can be provided in the vehicle, for example in conjunction with the engine electronics, the display of data on the dashboard and for the electronic control of the generation of compressed air. The compressed air is generated by a compressor and stored in at least one container, from which the compressed air consumers are fed according to requirements. In the case of a positive drive of the compressor by the vehicle engine, the air pressure in the container is regulated by means of an overpressure valve, which discharges air cyclically. In modern systems, the compressor feeds according to requirements and can operate concomitantly without compression by opening a valve or can be disconnected from the drive by a clutch, in particular as a function of the pressure of the container.

The compressed air that is generated has a high water content. A portion of the water is precipitated through condensation and can be discharged. Another portion of the water is present in the saturated compressed air. The compressed air is therefore passed through an air dryer. The moisture is picked up by a desiccant, in particular in the form of a dryer cartridge. The desiccant has to be regularly regenerated by feeding in dry air, which can be extracted from the compressed air system. The regeneration cycles of the air dryer can be controlled by a separate ECU, which can be connected to the other ECUs of the vehicle via the databus. The ECU of the air dryer can, at the same time, also control the compressor and receives data from pressure sensors. The pressure sensors convey at least the pressure in the container, but can be additionally arranged at various locations in the compressed air system, for example in individual brake circuits, at the brakes and/or at the air dryer.

The seal of the compressed air system is particularly important for the function of the compressed-air brakes. The air pressure is displayed at least on the vehicle dashboard; hitherto, the pressure in the container or in the brake circuits has been displayed. However, in most cases, all that could be sensibly interpreted with respect to the seal is a measurement when the vehicle is stationary or when the engine is switched off, i.e., without activation of the brakes, without regeneration of the dryer and without the compressor running. Hitherto, leaks in the supply system of the compressed-air brake system could be detected; but leaks in lines and volumes to which pressure is applied when braking occurs have hitherto not been detectable.

### SUMMARY OF THE INVENTION

Generally speaking, it is an object of the present invention to provide a method and a brake control device for detecting leaks in a vehicle compressed air system even when the vehicle is operating.

According to an embodiment of the present invention, the brake control device directly reads out data of at least one pressure measurement of the compressed air and processes the data for diagnostic purposes. Pressure sensors are connected directly, that is, not via the CAN bus, to the brake control device and can therefore transfer the determined pressure values with high resolution and speed to the brake control device. In the brake control device, the pressure values are correlated with the data of wheel speed sensors, with a brake pedal position and/or a brake pedal pressure. As a result, leaks in the compressed air system of the brake, for example in the lines or brake cylinders, can be detected during operation.

Additionally, the pressure values can be correlated with the actions of the closed-loop braking intervention control (ABS, EBS, ETCS, etc.) in order to differentiate the desired air consumption from leaks. If the calculations carried out with the available data indicate a leak, a warning to the operating personnel and/or an entry in a fault memory of the vehicle can be triggered. Such commands are advantageously transmitted via the databus, for example from ECU to ECU.

Also, leaks in individual brake circuits can be detected and monitored. In addition, the brake signals, which are determined and which are available in the brake control device, are transmitted to other ECUs in order to reduce the overall number of sensors in the vehicle.

According to an embodiment of the present invention, the pressure values can be correlated with the status of the compressor, the compressor control or the regeneration of the air dryer, in particular with information from an electronically controlled air conditioning system, in order to avoid false alarms.

Advantageously, the inventive embodiments provide for improved diagnosis of the brake system, enable shorter diagnosis times in the workshop, avoid the need to exchange incorrect parts, and yield higher operational reliability of the brake system.

Another embodiment is directed to a device for operating compressed-air brakes, in particular for carrying out the specified method. A brake control device is provided, in particular, with closed-loop braking intervention control, wherein one or more pressure sensors for compressed air is/are assigned to the brake control device and its/their measured values can be read out by the brake control device. The pressure sensor(s) is/are advantageously arranged in a brake circuit, in a plurality of brake circuits or in the compressed air system outside the brake circuits, and measure(s), in particular, air pressure in the brake circuit and/or system pressure. Pressure sensors can also be provided at different locations, for example in brake lines or at brake cylinders.

Still other objects and advantages of the present invention will in part be obvious and will in part be apparent from the specification.

The present invention accordingly comprises the various steps and the relation of one or more of such steps with respect to each of the others, and embodies features of construction, combinations of elements, and arrangement of parts, which are adapted to effect such steps, all as exemplified in the following detailed disclosure, and the scope of the invention will be indicated in the claims.

### BRIEF DESCRIPTION OF THE DRAWINGS

For a fuller understanding of the inventive embodiments, reference is had to the following description taken in connection with the accompanying drawings in which:

FIG. 1 is a diagram showing a brake control device, connected sensors and actuators, and a portion of a pneumatic system of a motor vehicle equipped with compressed-air brakes, in accordance with one embodiment of the present invention; and

FIG. 2 shows an alternative embodiment of the construction depicted in FIG. 1.

### LIST OF REFERENCE NUMBERS

10 Foot brake valve
11 Handbrake valve
12 Front wheel
13 Front wheel
14 Brake cylinder
15 Brake cylinder
16 Rear wheel
17 Rear wheel
18 Brake cylinder with parking brake function
19 Brake cylinder with parking brake function
20 Compressed air container
21 Compressed air container
22 Valve
23 Valve
24 Connection for trailer
25 Connection for trailer
26 Brake control device
28 Wheel speed sensor
29 Wheel speed sensor
30 Wheel speed sensor
31 Wheel speed sensor
32 Modulator
33 Modulator
34 Relay valve
35 Axle modulator
36 Line for CAN bus
37 Voltage supply
38 Pressure sensor
39 Pressure sensor
40 Line
41 Line
42 Compressor
43 Air dryer
44 Overflow valve
45 Overflow valve
46 Non-return valve
47 Line node
48 Pressure sensor
49 Line

### DETAILED DESCRIPTION OF THE PREFERRED EMBODIMENTS

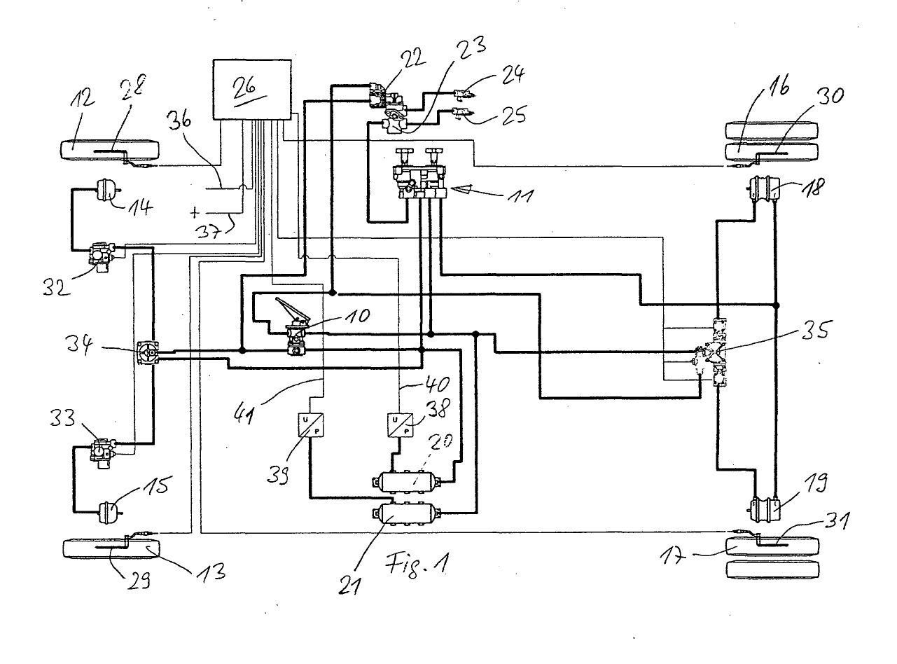

Referring now to the drawing figures, FIG. 1 shows a pneumatic brake system for a motor vehicle having two axles and including a foot brake valve 10, a handbrake valve 11, one brake cylinder 14, 15 per front wheel 12, 13, one brake cylinder 18, 19 per rear wheel 16, 17 (as twin tires here), with a parking brake function, as well as two compressed air containers 20, 21 for two separate brake circuits. Valves 22, 23 and ports 24, 25 are provided for a trailer (not shown). The specified parts are connected to one another via compressed air lines. The assemblies for generating and conditioning the compressed air are not shown in FIG. 1.

A closed-loop braking intervention control of the ABS type and/or within the scope of an EBS is assigned to the pneumatic brake system. A brake control device 26 is present for this brake system. The brake control device 26 receives signals directly from wheel speed sensors 28, 29 (at the front wheels) and wheel speed sensors 30, 31 (at the rear wheels) and evaluates them. On the basis of the received data, the brake pressures in the pneumatic lines are influenced to prevent or limit locking of the wheels during braking.

For this purpose, modulators 32, 33 are actuated by the brake control device 26. These are what are referred to as ABS valves, which can be used to regulate the pressure in the pneumatic lines. Each of the brake cylinders 14, 15 is assigned a modulator 32, 33.

The two modulators 32, 33 receive compressed air from a common relay valve 34, which is connected via compressed air lines both to the foot brake valve 10 and to the compressed air container 20.

In a similar way, a common axle modulator 35 is assigned to the brake cylinders 18, 19 for the rear wheels 16, 17. In the axle modulator 35 a plurality of functions are combined, including that of a relay valve and that of ABS valves as well as that of a differential valve for inputting compressed air in the unbraked operating mode, in particular for a traction control process.

The compressed air lines are shown in bold in the figures, while electrical lines, in particular data lines and signal lines, are, in contrast, shown using thinner lines. Electrical lines from the wheel speed sensors 28 to 31 to the brake control device 26 and from the latter to the modulators 32, 33 and the axle modulator 35 are shown. Furthermore, a line 36 for a CAN bus and a voltage supply 37 lead into the brake control device 26.

Each pressure sensor 38, 39 is assigned to one of the compressed air containers 20, 21, with the result that the pressure is monitored separately in each brake circuit. The pressure sensors 38, 39 are connected directly via lines 40, 41 to the brake control device 26, that is, not via a databus. This has the advantage that, when the motor vehicle is operating, testing of the sealing of the pneumatic system can be carried out by the brake control device 26 with high resolution. Braking processes that influence the pressure can be taken into account since the necessary data in the brake control device is available in close to real-time conditions and at a high resolution—the data being, for example, values of the wheel speed sensors 28 to 31, and/or, if appropriate, of pedal position sensors, of acceleration sensors, etc.

In FIG. 1, two pressure sensors 38, 39 are provided. In a simpler embodiment, just one of the two compressed air containers 20, 21 is assigned a pressure sensor.

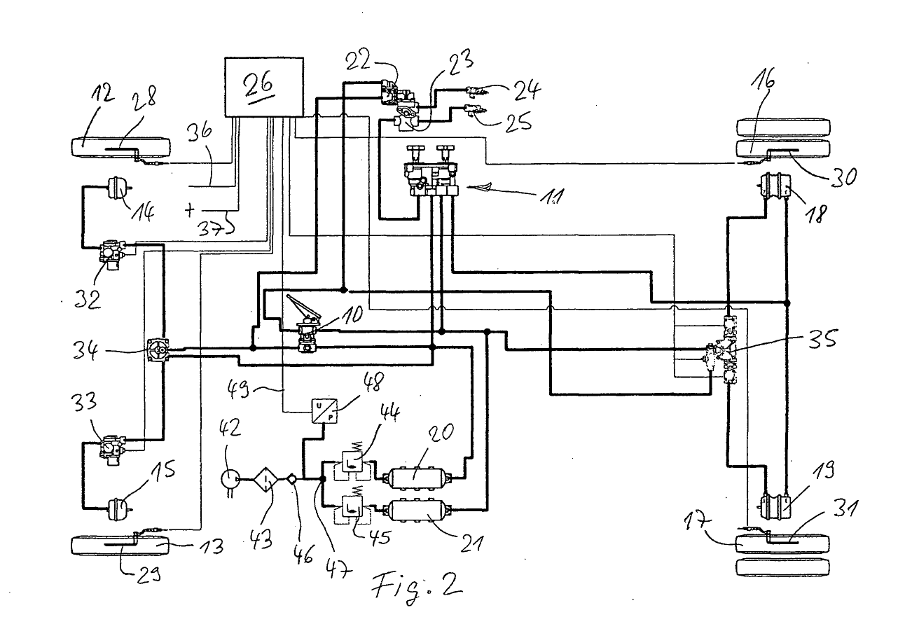

The embodiment depicted in FIG. 2 additionally includes, upstream of the compressed air containers 20, 21, assemblies for generating and conditioning compressed air, these being specifically a compressor 42 and an air dryer 43. Two overflow valves 44, 45 and a common non-return valve 46 are also provided between the air dryer 43 and the compressed air containers 20, 21. The three valves 44, 45, 46 are connected via lines in a star shape to a common line node 47. In this context, the non-return valve 46 is seated between the line node 47 and air dryer 43.

Instead of pressure sensors assigned to the compressed air containers 20, 21, in FIG. 2 a pressure sensor 48 is provided that measures a common system pressure. In this case, this is the pressure that is present at the node 47 or downstream of the non-return valve 46 in the direction of flow.

The overflow valves 44, 45 are, at the same time, non-return valves for the compressed air containers 20, 21.

The pressure sensor 48 is connected directly to the brake control device 26 via a line 49. In this exemplary embodiment, the brake control device 26 can also carry out testing of sealing on the basis of the connected sensors during operation.

Variations of the exemplary embodiments shown in FIGS. 1 and 2 are possible. For example, in FIG. 2 the pressure sensors 38, 39 according to FIG. 1 can be additionally provided with corresponding lines to the brake control device 26. Furthermore, for example, an additional pressure sensor can be provided in the supply circuit (not shown) for the trailer.

The brake control device 26 can be provided with different functionalities in addition to the ABS and to the testing of sealing, for example with acceleration sensors, a traction control system, an electronic stability control system, etc. The invention is therefore not restricted to an application in conjunction with an ABS. The brake control device 26 can also be part of a control device with another functionality.

Accordingly, the present invention enables sealing to be tested using the brake control device for closed-loop braking intervention control.

It will thus be seen that the objects set forth above, among those made apparent from the preceding description, are efficiently attained, and since certain changes may be made in the above processes and constructions without departing from the spirit and scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described and all statements of the scope of the invention that, as a matter of language, might be said to fall therebetween.

What is claimed is:

1. A method for operating a vehicle compressed-air brake system having a brake control device and a closed-loop braking intervention control function, the method comprising: using the brake control device, directly receiving and processing data representing at least one pressure measurement of compressed air, including at least one of (i) pressure in at least one brake circuit and (ii) brake system pressure.

2. The method as claimed in claim 1, wherein processing the data includes testing the sealing of at least one of (i) the at least one brake circuit and (ii) at least one brake cylinder.

3. The method as claimed in claim 1, further comprising, using the brake control device, evaluating at least one of (i) wheel speed sensors, (ii) a brake pedal pressure and (iii) a brake pedal position.

4. The method as claimed in claim 1, further comprising correlating the at least one pressure measurement with commands for effecting closed-loop braking intervention control.

5. The method as claimed in claim 1, further comprising, detecting whether there is a leak in the compressed-air brake system, and when a leak in the brake system is detected using the brake control device to generate a signal for at least one of display and entry in a fault memory.

6. The method as claimed in claim 1, further comprising correlating the at least one pressure measurement with at least one of (i) a status of a compressor, (ii) compressor control, and (iii) regeneration of an air dryer, using information from an electronically controlled air conditioning system of the vehicle.

7. A brake control device configured to effect the method for operating a vehicle compressed-air brake system as claimed in claim 1.

8. The brake control device of claim 7, the brake control device being configured to effect a closed-loop braking intervention control function.

9. The brake control device of claim 7, the brake control device being configured to receive pressure values measured using at least one pressure sensor.

10. The brake control device of claim 9, wherein the at least one pressure sensor is disposed in at least one of (i) the at least one brake circuit and (ii) the brake system at a location outside the at least one brake circuit, the at least one pressure sensor being configured to measure at least one of (a) pressure in the at least one brake circuit and (b) the brake system pressure.

11. A vehicle, comprising the brake control device as claimed in claim 7.
